(19) United States
(12) Patent Application Publication
(10) Pub. No.: US 2025/0007045 A1
(43) Pub. Date: Jan. 2, 2025

(54) BATTERY FIRE SUPPRESSION ARRANGEMENT

(71) Applicant: Patrick Scott Heller, Goshen, IN (US)

(72) Inventor: Patrick Scott Heller, Goshen, IN (US)

(21) Appl. No.: 18/756,837

(22) Filed: Jun. 27, 2024

Related U.S. Application Data
(60) Provisional application No. 63/511,372, filed on Jun. 30, 2023.

(51) Int. Cl. H01M 10/658; F16L 59/02; F16L 59/04; H01M 10/643; H01M 10/659; H01M 50/213; H01M 50/291; H01M 50/293

(52) U.S. Cl. CPC H01M 10/658; F16L 59/028; F16L 59/04; H01M 10/643; H01M 10/659; H01M 50/213; H01M 50/291; H01M 50/293

(57) ABSTRACT

A battery arrangement for fire suppression. The battery has a plurality of cells, each having an outer surface. A portion of the surfaces of adjacent cells are spaced from each other. Space between the cells is filled with a granular insulating material. The granular insulation may be a microporous insulation. In the case that microporous insulation is used, one of the compounds in the microporous insulation may be an endothermic compound that absorbs heat applied to the microporous insulation.

### CROSS REFERENCE TO RELATED APPLICATIONS

This application claims priority of U.S. Provisional application 63/511,372, filed Jun. 30, 2023, which application is hereby incorporated herein by reference.

### BACKGROUND OF THE INVENTION

Lithium-ion battery technology has had an extensive proliferation in recent years due to the light weight and high energy density of lithium-ion batteries. Lithium-ion batteries are used in power tools, personal transportation devices (such as bikes and scooters), and in electric automobiles.

Generally, lithium-ion batteries are made of many smaller standard cylindrical cells that are wired together to form a larger battery. Shapes other than cylindrical cells may be used as well, but cylindrical cells are commonly used because they are readily available. A large battery, such as those used in automotive applications, may have thousands of individual cells packaged together to form a large capacity battery. Power tools and personal transportation devices still have many cells wired together to provide a battery that has sufficient capacity and voltage to perform its intended function.

As is well known in the industry, lithium-ion batteries are sensitive to heat. Heating lithium-ion batteries can cause them to violently explode. During such a violent explosion, hot battery parts and gasses can ignite a fire that will consume everything in its path. In some instances, the heat that causes damage to a multi-cell lithium battery may begin in a single cell within the battery. In such cases, that single cell may then generate heat, and cause an adjacent cell to be heated. Such a failure can cause a catastrophic chain reaction that is referred to as thermal runaway because the battery violently self-destructs and many, if not all of the cells, of the battery ignite.

### SUMMARY OF THE INVENTION

The present invention is a battery with an arrangement for fire suppression. The battery has a plurality of cells and each of the cells has an outer surface. The cells are configured so that a portion of the outer surface of the cells are spaced from outer portions of cells adjacently located. The space between the cells form at least one interstice between the cells. The interstices between the cells are filled with a granular insulating material. The cells are within a container that has a sidewall surrounding the cells.

The cells of the battery may be in direct contact with each other or may be spaced apart so that no part of the outer surfaces of adjacent cells contact each other.

The granular insulation may be a microporous insulation. In the case that microporous insulation is used, one of the compounds in the microporous insulation may be an endothermic compound that absorbs heat applied to the microporous insulation.

### BRIEF DESCRIPTION OF THE DRAWINGS

FIG. 1 is a perspective view of a battery showing the cells in an enclosure having the top not shown for clarity showing no granular insulation around the cells for clarity;

FIG. 2 is a top view of the battery shown in FIG. 1 showing granular insulation surrounding the cells;

FIG. 3 is a top view of another embodiment of a battery showing granular insulation around the cells of the battery with the cells contacting each other and the enclosure spaced from the cells;

FIG. 4 is a top view of another embodiment of a battery showing granular insulation around the cells of the battery with the cells contacting each other and the enclosure contacting the cells;

FIG. 5 is a sectional view of the battery shown in FIGS. 1 and 2 taken about line 5-5 in FIG. 1, showing the granular insulation between the cells that was not shown in FIG. 1;

FIG. 6 is a sectional view of another battery having non-cylindrical cells;

FIG. 7 is a block diagram showing the mixing of the microporous insulation; and

FIG. 8 is a top view an array of nested cells showing the relatively small interstices.

### DETAILED DESCRIPTION OF INVENTION

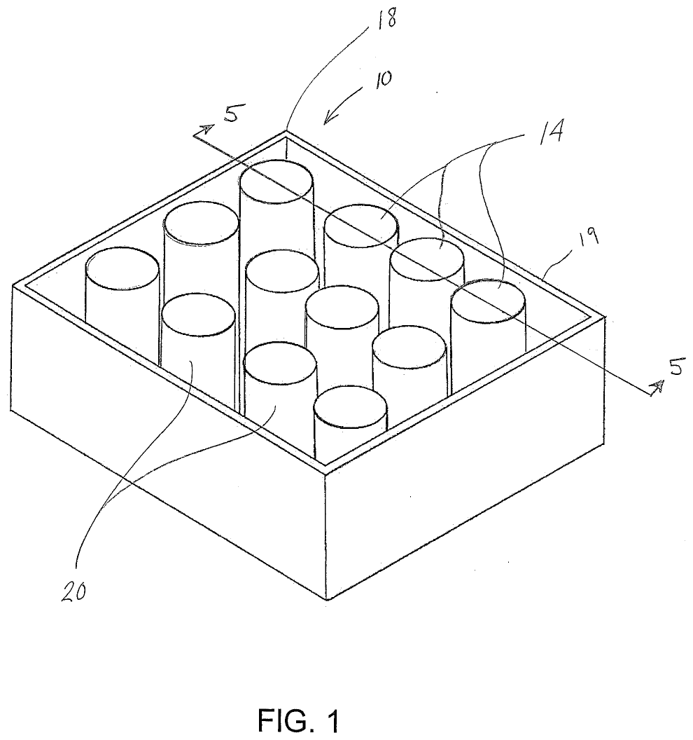

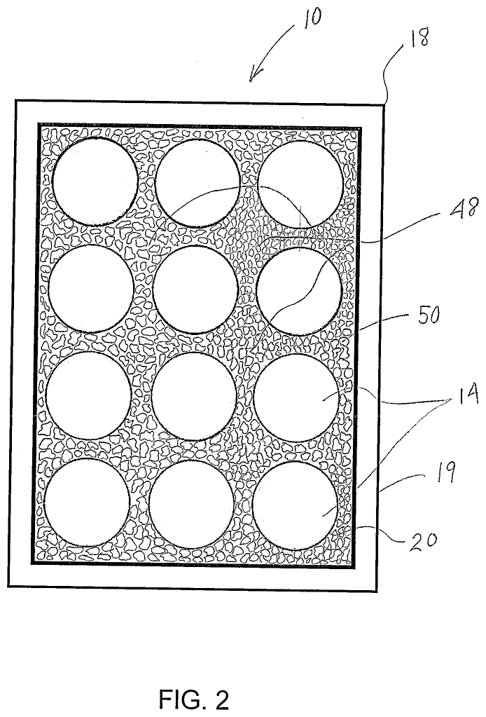

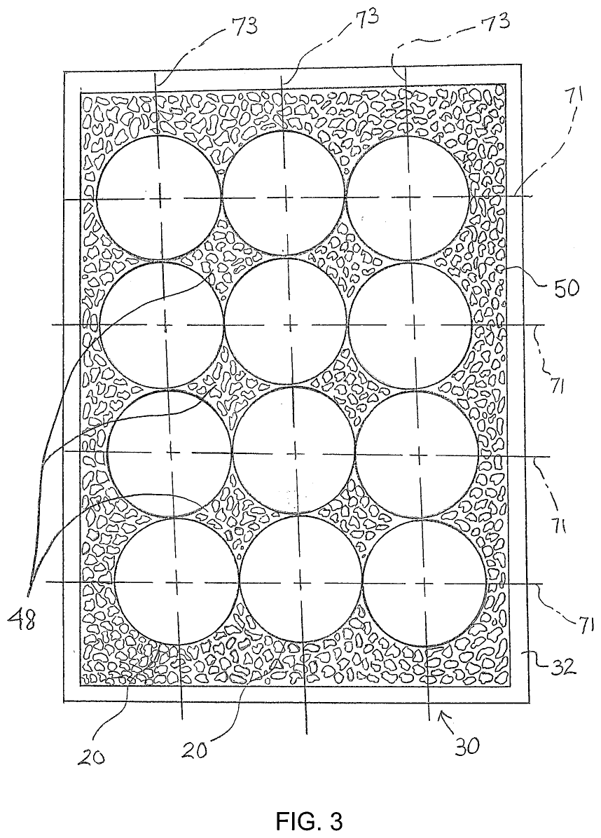

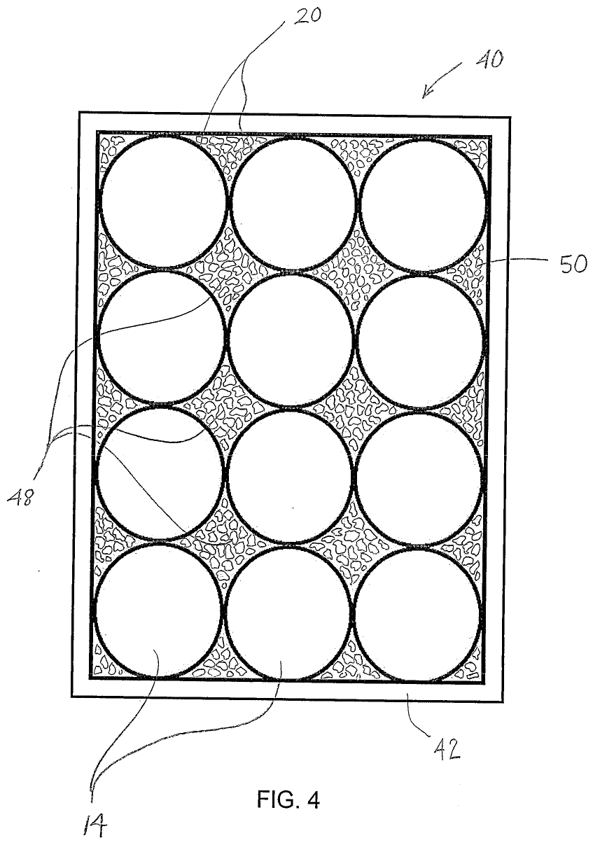

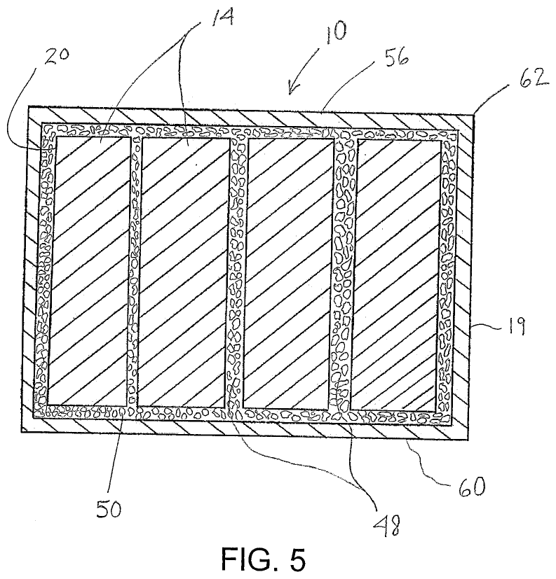

FIG. 1 shows an embodiment of the invention that is a battery 10 having an array of cells 14 that are in an enclosure 18. The cells 14 of the battery are electrically connected (which is not shown) to form the battery 10 and are in close proximity within an enclosure 18. The enclosure 18 has a sidewall 19 that surrounds and contains the cells 14 within the battery 10. The cells 14 of the battery 10 shown in FIG. 1, are cylindrical. This is common amongst many battery configurations, in particularly lithium-ion batteries. When the cells 14 are cylindrical, each cell 14 has an outer surface 20. The outer surfaces 20 of the cylindrical cells 14 may be in direct contact or spaced apart. The geometry of cylindrical cells 14 being adjacent to each other means that portions of the of adjacent outer surfaces 20 are necessarily spaced apart whether they are in direct contact or spaced apart. The space between the outer surfaces 20 of the cells 14 is the case for the battery shown in FIGS. 1 and 2, and is also true for the battery 30 shown in FIG. 3 and in the battery 40 shown in FIG. 4. The battery 10 shown in FIGS. 1 and 2 have the cells 14 spaced apart with no part of the cells 14 contacting each other. The batteries 30, 40 shown in FIGS. 3 and 4, respectively have portions of the cells 14 directly contacting each other. Batteries 30 and 40, have relatively small portions of the cells 14 contacting each other, which still leaves a significant amount of space between most of the cells 14. The battery 30 shown in FIG. 3 has a sidewall 32 that surrounds the cells 14 and is spaced from cells 14 packed therein. The battery 40 shown in FIG. 4 has a sidewall 42 that surrounds the cells 14 and the sidewall 42 is in contact with the cells 14 packed therein. In the case of battery 40, the sidewall 42 only contacts a small portion of some of the cells 14. In each of the batteries 10, 30, 40, discussed above, there are interstices 48 between the adjacent cells 14 that are spaces for receiving granular insulation 50. The interstices 48 present in the batteries 30, 40 are possible even though the cells 14 touch each other because the outer surfaces 20 are curved, which is due to the cylindrical shape of the cells 14. In addition to the interstices 48 due to the curved outer surfaces 20, the cells 14 may be spaced at a distance from each other so that the outer surfaces 20 of adjacent cells 14 are spaced from each other even at their nearest portions, as shown in FIGS. 1 and 2. In the batteries 10, 66 shown in FIGS. 1, 2, 5 and FIG. 6, none of the cells 14 contact any other cells 14. This spacing provides extra room for granular insulation 50. The batteries 30, 40 of FIGS. 3 and 4, respectively have cells 14 that directly contact each other. In the case of the battery 30 shown in FIG. 3, the spacing between the sidewall 32 and the cells 14 allows room for the granular insulation 50 to prevent heat from any cell 14 from leaving the battery 30 or affecting any other cells 14. It should be noted that FIG. 5 is a sectional view of the battery 10 shown in FIG. 1 having cylindrical cells 14 and FIG. 5 shows the granular insulation 50 that is omitted in FIG. 1 for clarity. FIG. 5 also shows a top wall 56 and a bottom wall 60 that are connected to the sidewall 19 to form an enclosure 62 that completely contains the cells 14. For clarity, the top wall 56 and bottom wall 60 are not shown in FIGS. 1 and 2. It is possible that the battery 30 of FIG. 3 and the battery 40 of FIG. 4 contain no top wall 56 or bottom wall 60 because the sidewall 32, 42 is sufficient to retain the cells 14 together. However, having a top wall 56 and bottom wall 60 provides full enclosure for the cells 14 and an opportunity to include more granular insulation 50. It is contemplated that the cells 14 in some instances may be shrink wrapped to contain them and hold the granular insulation 50. In such a case, it is possible that the top and bottom of such an arrangement would be open.

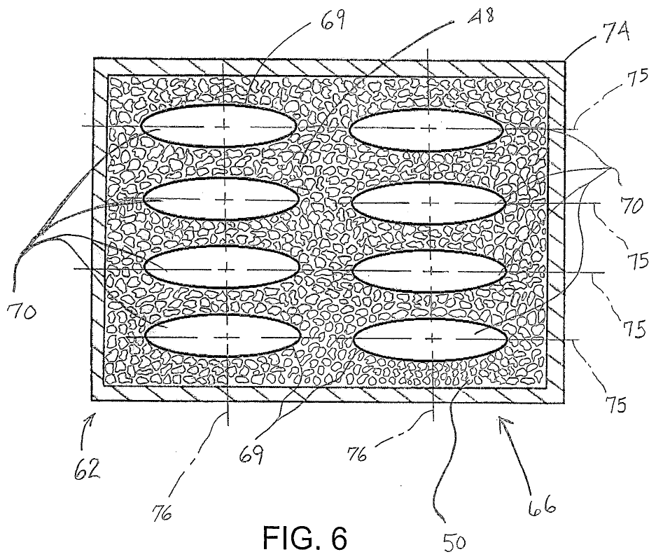

The battery 66, shown in FIG. 6, is a type of battery 66 having cells 70 that are not cylindrical. Each non-cylindrical cell 70 has a shape that is oblong having an outer surface 69. The interstices 48 between the cells of this type of battery may be filled with the granular insulation 50. The battery 66 has an enclosure 74 in the same manner as the previously described embodiments. For the application of battery 66, the granular insulation 50 serves the same purpose as described above. In the batteries 10, 66 (FIGS. 1, 2, 5; and FIG. 6 respectively) the granular insulation 50 not only serve the function of heat isolation, but also serve to fix the position of the cells 14, 70 with respect to each other. Prior art batteries have often used spacers to serve this function that are more cumbersome and expensive, while the granular insulation 50 of the present invention provide significantly more flexibility due to the complementary fit with any type of cell 14, 70. In this manner of packaging, the granular insulation 50 acts as a complementary fitting packing material that conforms to the shape of the cells 14, 70 that the granular insulation 50 surrounds. Thus, the granular insulation 50 serves as a spacer to keep the cells 14 from shifting relative to each other.

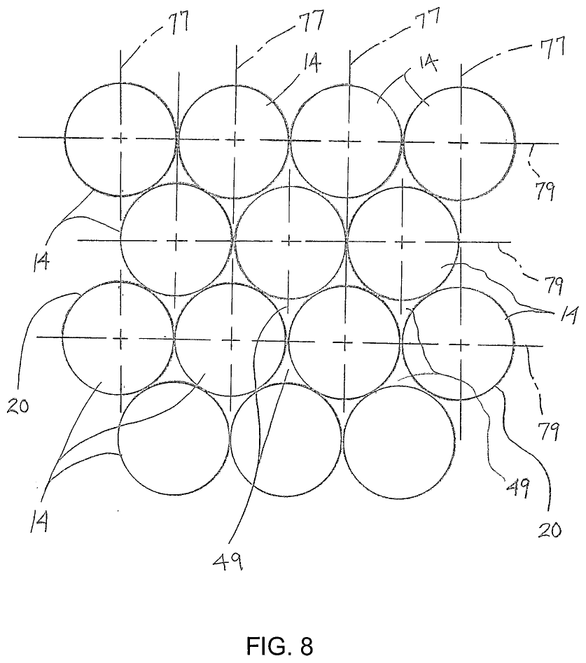

The arrangement of the cells 14, 70 is done in a manner to provide sufficient space between them to accommodate the granular insulation 50 in sufficient quantity to insulate the cells 14, 70 from each other. Spacing cells 14, 70 too far apart would dimmish the utility of lithium-ion batteries because a key feature of their utility is that they provide a relatively large amount of power in a small package. Thus, a tradeoff must be made that provides enough room for the granular insulation 50 and still allows a relatively small package of cells 14, 70 to form a battery 10, 30, 40, 66. In a one arrangement, cells 14, 70 are arranged in a non-nested configuration, as shown in FIGS. 2 and 6. A non-nested configuration provides contact of adjacent cells 14 along the central axes 71, 73; 75, 76 of their cross-sectional area. For instance, the battery 30 in FIG. 3 shows cylindrical cells 14 that have line contact along their length at the respective diameters, which are the central axes 71, 73 of the cylindrical cells 14. This non-nested configuration allows a majority of the surface of the adjacent cells 14 to be spaced apart while the cells 14 are in contact. As such, the interstices 48 accommodate a significant amount of granular insulation 50 that will shield adjacent cells 14 from each other to prevent a thermal runaway event. A nested configuration is the opposite of the non-nested configuration and is illustrated in FIG. 8. In the nested configuration, cells 14 are arranged in a tighter array. In the nested configuration, the central axes 77, 79 are staggered in successive rows so that one cell 14 can touch as many as six other cells 14. In other words, the central axes 77, 79 are not aligned in the nested configuration. In the non-nested configuration, the cells 14 can only touch four other cells corresponding to where their central axes 71, 73 align. In the nested configuration, the interstices 49 are smaller than in the non-nested configuration. In the non-nested configuration, the central axes 71, 73 as shown in FIG. 3, are aligned providing for larger interstices 48 than in the nested configuration as shown in FIG. 8. The nested configuration is extremely dangerous in an uninsulated condition because the cells 14 are in closer proximity and each cell 14 contacts more cells than in a non-nested configuration. The granular insulation 50 of the present invention makes the tightly packed cells 14 in the nested configuration shown in FIG. 8 significantly less dangerous than conventional uninsulated and nested cells 14. It is also contemplated that non-round or oblong cells 70 such as those shown in FIG. 6 can be placed in the nested or non-nested configuration and the same properties would be true. For instance, the cells 70 in FIG. 6 as arranged could touch directly along their aligned axes 75, 76 and would be non-nested as shown if they were just drawn closer together along their respective axes 75, 76.

The granular insulation 50 may be one of many types that prevents heat from traveling therethrough. In the present invention, the granular insulation 50 that has achieved significant results has been microporous insulation. The granular insulation 50 has the ability to flow into the interstices 48 between the cells 14 in a complementary fashion that will accommodate any type of cells 14 that are used. This provides the maximum insulation of the cells 14 from each other. In other words, the granular insulation 50 conforms to the shapes of the interstices 48 between the cells to maximize the volume filled between the cells in a complementary fashion that accommodates the shapes of the interstices 48.

The granular insulation 50 includes endothermic compounds within the insulation structure which enhances the already excellent insulating properties of the microporous insulation granular insulation 50. Unlike other types of insulation for high temperature insulation that achieves significant insulation at high temperatures, there is no phase changing material, such as wax, within the granular insulation 50. The endothermic compounds within the granular insulation 50 can release chemically and/or mechanically bound water and/or other gases which carry away additional heat from cells 14 being insulated from each other. This release of chemically bound water may also carry heat away when that heat is supplied by any source outside of the battery 10, 30, 40 that may cause the cells 14 to overheat, which can prevent the heat from leading to a thermal runaway event.

The granular insulation 50 of the present invention is especially suitable for insulating applications involving fire and other high temperature environments. The granular insulation 50 material of the invention contains inorganic particulate material; an endothermic compound; (optionally) an opacifier; inorganic fiber; water; and preferably, where structural integrity is required, a dry resin binder. The inorganic particulate material can be hydrophilic and can be processed as a dry powder. The inorganic particulate material can also be partially hydrophilic and partially hydrophobic and be processed to allow the absorption of water. The amount of water that the granular insulation 50 will hold is controlled by the amount of hydrophilic particulate material used in the insulation. The structural integrity of the insulation is maintained by the hydrophobic particulate material in the granular insulation 50. The addition of water to the microporous insulation material results in an insulation that maintains the temperature of the insulation material at about 250° F. or below for an extended period of time during environmental exposures of up to 2000° Fahrenheit. This is extremely useful in the present invention because thermal exposures of significantly less than 2000° F. can cause a catastrophic thermal runaway event.

The granular insulation 50 of the present invention contains the following ingredients at the indicated weight percentage levels or ranges which are based upon the dry weight of the microporous insulation material prior to adding any water to the water saturated embodiments.

TABLE 1

| INGREDIENTS | WT % |
|---|---|
| Inorganic Particulate Material(s) | 20-60 |
| Endothermic Compound(s) | 10-60 |
| Opacifier(s) | 05-20 |
| Inorganic Reinforcing Fiber | 03-15 |
| Dry Resin Binder | 0-06 |

Alternatively, the microporous insulation material may comprise:

TABLE 2

| INGREDIENTS | WT % |
|---|---|
| Inorganic Particulate Material(s) | 20-80 |
| Endothermic Compound(s) | 05-75 |
| Opacifier(s) | 0-30 |
| Inorganic Reinforcing Fiber | 01-15 |
| Binder | 0-06 |

Again, these ranges are based upon the dry weight of the granular insulation 50 material prior to adding any water to the water saturated embodiments. In appropriate circumstances, any individual ingredient range from Table 2 may be substituted for the corresponding range shown in Table 1.

The inorganic particulate material(s) and the endothermic compound(s) make up 50 to approximately 89 wt % of the granular insulation 50 material. The granular insulation 50 material to be used in dry systems where moisture can be detrimental to the item or assembly being insulated and shielded, uses a hydrophilic inorganic particulate material. When some moisture can be tolerated, the granular insulation 50 can use a blend of the inorganic particulate materials with about 50-95 wt % of the inorganic particulate material being hydrophilic and about 5-50 wt % of the inorganic particulate material being hydrophobic with preferably about 70-95 wt % of the inorganic particulate material being hydrophilic and about 5-30 wt % of the inorganic particulate material being hydrophobic.

In one preferred embodiment of the present invention, the granular insulation 50 material comprises about: (a) 34-38 wt % inorganic particulate material; 47-51 wt % endothermic compound(s); 7-8 wt % opacifier(s); 4-6 wt % inorganic fiber; and 0-3 wt % dry resin binder. Two examples of this embodiment are a microporous insulation material which contains about: (a) 36.5 wt % fumed silica with a surface area of about 200 m²/g; 49 wt % aluminum trihydrate; 7.5 wt % silicone powder; 4 wt % quartz fiber; 1 wt % glass fiber; and 2 wt % phenol formaldehyde wherein the fumed silica is hydrophilic and a microporous insulation material; identical to the first microporous insulation material, except that the fumed silica is about 85 wt % hydrophilic and 15 wt % hydrophobic, plus the addition of water.

In a second preferred binderless embodiment, the granular insulation 50 material comprises about: 28-32 wt % inorganic particulate material(s); 48-52 wt % endothermic compound(s); 13-17 wt % opacifier(s); and 4-5 wt % inorganic fiber. Two examples of this second preferred embodiment are a microporous insulation material containing about: 30.5 wt % fumed silica with a surface area of about 200 m²/g; 50 wt % alumina trihydrate; 15 wt % silicone powder; and 4.5 wt % glass and amorphous wool fiber wherein the fumed silica is hydrophilic and a second microporous insulation material, identical to the first, except that about 85 wt % of the fumed silica is hydrophilic and 15 wt % of the fumed silica is hydrophobic plus water.

Yet another preferred embodiment of the present invention is a microporous insulation material comprising approximately 40 wt % inorganic particulate materials, approximately 49 wt % endothermic compound(s), approximately 6 wt % inorganic fibers, and approximately 5 wt % binder. In this embodiment, 30 wt % of the material is fumed alumina, with the remaining 10 wt % of the inorganic particulate materials being fumed silica. Various other embodiments may include fumed alumina instead of any or all of any fumed silica otherwise present as an inorganic particulate material.

The hydrophilic inorganic particulate material employed in the present invention acts as a filler and a bulking agent in both the dry insulation system and the wet insulation system of the present invention. In the wet insulation system, the hydrophilic inorganic particulate material also functions to absorb and retain water which undergoes a phase change at about 212° F. to maintain the granular insulation 50 at about this temperature for an extended period of time. Examples of hydrophilic particulate material which can be utilized in the present invention include, but are not limited to, fumed silica, silica fume, precipitated silica, micron size synthetic amorphous silica and other fumed oxides. The surface area of the hydrophilic inorganic particulate material will generally be greater than 100 m²/g, and preferably, greater than about 150 m²/g.

The hydrophobic inorganic particulate material functions to make the granular microporous insulation 50 microporous and thermally efficient and to maintain the structural integrity of the microporous insulation after water has been introduced into the microporous insulation material and absorbed by the hydrophilic inorganic particulate material. Examples of hydrophobic inorganic particulate materials, which can be utilized in the present invention include, but are not limited to, fumed silica, silica fume, precipitated silica, micron size synthetic amorphous silica, and other fumed oxides which have been surface treated to make the materials hydrophobic. A preferred hydrophobic inorganic particulate material is fumed silica which has been surface treated with silane to make the fumed silica water resistant. The surface area of the hydrophobic inorganic particulate material will generally be greater than about 50 m²/g and preferably, greater than about 90 m²/g.

At least one endothermic compound is employed in the microporous insulation material of the present invention. Examples of the forgoing endothermic compounds, which can be utilized in the present invention, include, but are not limited to, alumina trihydrate, magnesium carbonate-hydrate, melamine, and water. As used herein, the term “endothermic compound,” with respect to alumina trihydrate and magnesium carbonate-hydrate, means that these materials are endothermic upon dehydration.

At least one opacifier is employed in some embodiments of the microporous insulation material of the present invention. Examples of suitable opacifying agents, which can be utilized in the present invention are silicone, titania, calcined clay, magnesium oxide, silicon carbide, carbon and other metal oxides.

At least one type of inorganic fiber is employed in the microporous insulation material of the present invention. Examples of suitable inorganic fibers, which can be used in the present invention, are quartz fibers, glass fibers, refractory fibers, amorphous fibers, and mineral wool fibers.

When a binder is employed in the microporous insulation material of the present invention, preferably the binder is a dry resin binder such as, phenol formaldehyde or other thermosetting resins. Those skilled in the art will recognize that other suitable binders exist or may be used as well.

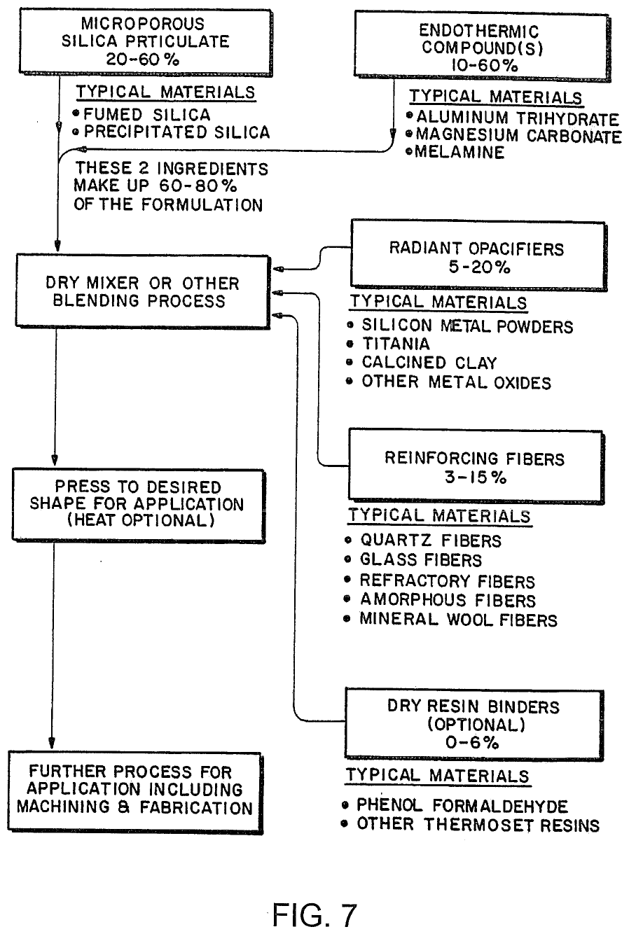

Preferably, as schematically illustrated in FIG. 7, the microporous insulation material of the present invention is made by preparing a dry mixture of the inorganic particulate material (hydrophilic or a blend of hydrophilic and hydrophobic) and endothermic compound(s) and introducing the inorganic particulate material and endothermic compound(s) into a dry mixer. The opacifier(s), the inorganic reinforcing fibers, and the dry resin binder (if used) are also added to the dry mixer and the ingredients are blended. The blended ingredients forming the microporous insulation material may then be pressed to a desired shaped in a conventional press. If desired, heat may be applied to set the binder. The desired shape from the press for the present application is to form the microporous insulation into briquettes that may be put into a moving jaw crusher that is similar to a conventional rock crusher. The insulation briquettes are then sifted to a size of 2 mm and smaller. This provides an optimum size for granular insulation 50 used to insulate cells 14 of a battery. It also provides an extremely rough surface for each granule that adds to the surface area. The crushed texture of the granular insulation 50 resulting from this process means the granules have high friction and large surface area surface that prevents easy shifting of the granules once they are packed into a confined area. The granules are irregular with sharp corners to provide an interlocking fit within the granular insulation 50 and this helps secure them from movement and prevents shifting of the cells 14. The relatively small particle size provides a tortuous path for any gasses that may leave cells 14 as they outgas. This will slow the propagation of hot gasses that could cause an unstoppable chain reaction, resulting in a thermal runaway event that could cause every cell 14 to ignite. The rough surface texture of each granule also adds to the tortuous path through the granular insulation 50 though which any gas or particulate discharge would necessarily be forced to travel through. The chemical composition of the granular insulation 50 will absorb a significant amount of heat through endothermic reactions. The granular insulation 50 will also absorb mechanical shock due to the friction between the many granules and somewhat deformable nature of the granules within the granular insulation 50. The absorption of shock is also enhanced by the interlocking nature of the sharp edge granules within the granular insulation 50.

The invention is not limited to the details given above, but may be modified within the scope of the following claims.

What is claimed is:

1. A battery comprising:
a plurality of cells having an outer surface;
a container surrounding said cells said container having a sidewall surrounding said cells;
said cells being configured so that portions of said outer surfaces of said cells are spaced from outer portions of said cells located adjacent thereto, said spaces forming at least one interstice between said adjacent cells, said interstice being filled with a granular insulating material.

2. The battery of claim 1, wherein said cells located adjacent to each other have their entire said outer surfaces spaced apart.

3. The battery of claim 1, wherein said cells located adjacent to each other have a portion of their said outer surfaces in contact.

4. The battery of claim 1, wherein said cells are in direct contact with said sidewall surrounding said cells.

5. The battery of claim 2, wherein said sidewall is spaced from said outer surfaces of said cells.

6. The battery of claim 5, wherein said sidewall is connected to a bottom wall and said sidewall is connected to a top wall spaced from said bottom wall, said sidewall said bottom wall and said top wall forming an enclosure enclosing said cells.

7. The battery of claim 1, wherein said cells are in a nested configuration.

8. The battery of claim 1, wherein said cells are in a non-nested configuration.

9. The battery of claim 1, wherein said granular insulating material comprises in weight percent:
(a) 20-80 wt % inorganic particulate material;
(b) 5-75 wt % endothermic compound;
(c) an opacifier, said opacifier present up to 30 wt %;
(d) 1-15 wt % inorganic fiber;
(e) 0-6 wt % binder; and
(f) 50 to approximately 89 wt % being said inorganic particulate material and said endothermic compounds, said inorganic particulate material being a different substance than said endothermic compound.

10. The battery of claim 9, wherein said inorganic fiber is fiberglass.

11. The battery of claim 10, wherein said granular insulating material is sized to be comprised of granules 2 mm and smaller.

12. A battery comprising:
a plurality of cells having an outer surface;
a container surrounding said cells in said container having a sidewall surrounding said cells;
said cells being configured so that portions of said outer surfaces of said cells are spaced from outer portions of said cells located adjacent thereto, said spaces forming at least one interstice between adjacent cells, said interstice being filled with a granular insulating material wherein said granular insulating material includes an endothermic compound.

13. The battery of claim 12, wherein said granular insulating material comprises in weight percent:
(a) 20-80 wt % inorganic particulate material;
(b) 5-75 wt % endothermic compound;
(c) an opacifier, said opacifier present up to 30 wt %;
(d) 1-15 wt % inorganic fiber; and
(e) 0-6 wt % binder.

14. The battery of claim 13, wherein said endothermic compound and said inorganic particulate material being a different substance.

15. The battery of claim 14, wherein said cells are in a nested configuration.

16. The battery of claim 14, wherein said cells are in a non-nested configuration.

17. A battery comprising:
a plurality of cells having an outer surface;
a container surrounding said cells said container having a sidewall surrounding said cells;
said cells being configured so that portions of said outer surfaces of said cells are spaced from outer portions of said cells located adjacent thereto, said spaces forming at least one interstice between said adjacent cells, said interstice being filled with a granular insulating material having a crushed texture.

18. The battery of claim 17, wherein said granular insulating material comprises in weight percent:
(a) 20-80 wt % inorganic particulate material;
(b) 5-75 wt % endothermic compound; and
(c) an opacifier, said opacifier present up to 30 wt %.

19. The battery of claim 17, wherein said cells are in a nested configuration.

20. The battery of claim 17, wherein said cells are in a non-nested configuration.
